(19) United States
(12) Patent Application Publication
(10) Pub. No.: US 2020/0282483 A1
(43) Pub. Date: Sep. 10, 2020

(54) THREADING TOOL WITH INTERCHANGEABLE GUIDE INSERTS

(71) Applicant: Joseph Trerotola, West Haven, CT (US)

(72) Inventor: Joseph Trerotola, West Haven, CT (US)

(21) Appl. No.: 16/295,100

(22) Filed: Mar. 7, 2019

(51) Int. Cl. B23G 5/10; B23G 1/52; B23G 1/26

(52) U.S. Cl. CPC B23G 5/103; B23G 1/52; B23G 2200/12; B23G 2200/08; B23G 1/267

(57) ABSTRACT

A threading tool is disclosed that uses interchangeable guide inserts to ensure that pipes or rods of various diameters are maintained at a perpendicular angle to a threading die. The threading tool includes a housing and a guide insert. The housing includes a first opening at one end and a second opening at an opposite end. The housing defines a first region having a first width adjacent to the first opening and a second region having a second width adjacent to the second opening. The second width is greater than the first width. The guide insert is designed to fit through the first opening and is removably secured within the first region. The second region is shaped to fit a threading die, and the threading die is removably secured in the second region.

### BACKGROUND

Threaded parts are used in many applications to provide an effective seal for pipes transporting liquids, gases, steam, or hydraulic fluid, and for fasteners such as bolts, screws, and studs. While many tools exist for threading the end of a given pipe or rod, there are still some challenges with doing so.

### BRIEF DESCRIPTION OF THE DRAWINGS

Features and advantages of embodiments of the claimed subject matter will become apparent as the following Detailed Description proceeds, and upon reference to the Drawings, in which:

FIG. 1 illustrates a perspective, exploded view of a threading tool, in accordance with an embodiment of the present disclosure.

FIGS. 2A and 2B illustrate cross section views of the threading tool, in accordance with some embodiments of the present disclosure.

FIGS. 3A-3C illustrate cross section views of the threading tool with a pipe being threaded therein, in accordance with some embodiments of the present disclosure.

FIG. 4 is a flowchart of a method for using the threading tool, in accordance with an embodiment of the present disclosure.

Although the following Detailed Description will proceed with reference being made to illustrative embodiments, many alternatives, modifications, and variations thereof will be apparent in light of this disclosure.

### DETAILED DESCRIPTION

As noted above, there are some non-trivial issues associated with correctly threading pipe or a solid rod. For ease of discussion, a pipe is used herein as an example of an object to be threaded, however, the threading tool can be used in the same way to thread the end of solid rods. For many threading tools, a pipe is inserted into a threading die, which is then rotated around the pipe to cut into the pipe and create the threaded pattern. However, if the pipe is not placed into the die at just the right angle (e.g., perpendicular), the threading pattern will be slightly crooked along the threaded length of the pipe. This leads to problems when trying to then screw the pipe into the appropriate socket, as the pipe may not remain straight.

Techniques and designs are provided herein that mitigate the issues discussed above. In an example embodiment, a new threading tool is disclosed that uses interchangeable guide inserts to ensure that pipes (or rods) of various diameters are maintained at a perpendicular angle to a threading die. An example threading tool includes a housing and a guide insert. The housing includes a first opening at one end and a second opening at an opposite end. The housing defines a first region having a first width adjacent to the first opening and a second region having a second width adjacent to the second opening. The second width is greater than the first width. The guide insert is designed to fit through the first opening and is removably secured within the first region. The second region is shaped to fit a threading die, and the threading die is removably secured in the second region.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in an order different from the described example. Various additional operations may be performed, and/or described operations may be omitted in additional examples.

The description uses the phrases “in an embodiment” or “in embodiments,” which may each refer to one or more of the same or different embodiments. Furthermore, the terms “comprising,” “including,” “having,” and the like, as used with respect to embodiments of the present disclosure, are synonymous. When used to describe a range of dimensions, the phrase “between X and Y” represents a range that includes X and Y. For convenience, the phrase “FIG. 15” may be used to refer to the collection of drawings of FIGS. 15A-15C, the phrase “FIG. 16” may be used to refer to the collection of drawings of FIGS. 16A-16B, etc.

Spatially relative terms, such as “beneath,” “below,” “lower,” “above,” “upper,” and the like, may be used herein for ease of description to describe one element or feature's relationship to another element (s) or feature (s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

### Threading Tool Design

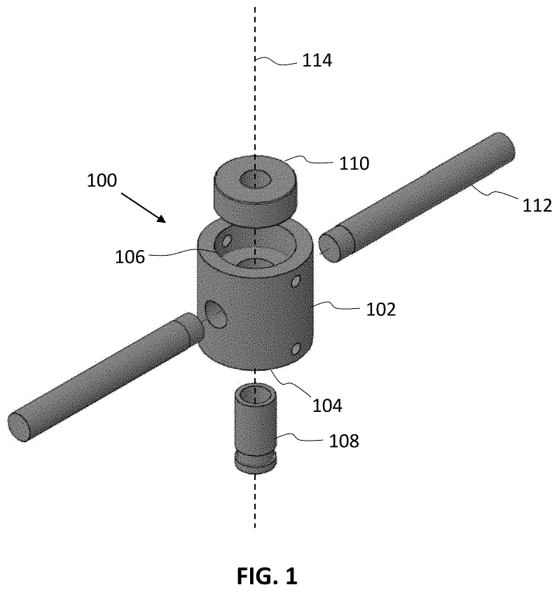

FIG. 1 illustrates a three-dimensional representation of a threading tool 100, according to an embodiment. Threading tool 100 includes a housing 102 that has a first opening 104 at one end and a second opening 106 at an opposite end. Housing 102 may define one or more internal regions that are each cylindrical in shape, as illustrated, and the one or more internal regions may be used to secure interchangeable elements. For example, a first region within housing 102 is shaped to fit a guide insert 108 while a second region within housing 102 is shaped to fit a threading die 110. In some embodiments, an outer shape of housing 102 is also cylindrical, as illustrated. Other possible outer shapes for housing 102 include hexagonal or octagonal. Housing 102 may be machined from a single block of material, or housing 102 may be composed of different pieces that are glued, welded, or otherwise coupled together. Housing 102 may be made of stainless steel or any other hard plastic or metal material.

According to some embodiments, guide insert 108 is designed to fit into first opening 104 of housing 102 and provides additional guidance and stability for a pipe while the pipe is being threaded by threading die 110. Guide insert 108 may be machined from a single block of material, or guide insert 108 may be composed of different pieces that are glued, welded, or otherwise coupled together. Guide insert 108 may be made of stainless steel or any other hard plastic or metal material. Guide insert 108 may have a hollow inner diameter (e.g., between about 0.2 inches and about 1.75 inches) that is sized for a particular pipe diameter. Guide insert 108 may have a length between about 0.5 inches and about 1.5 inches, although larger pipes may use longer guide inserts. In some embodiments, the inner diameter of guide insert 108 is adjustable for use with different pipe sizes. In some other embodiments, different guide inserts having different inner diameters can be interchangeably used within housing 102. In some embodiments, guide insert 108 has an inner shape that includes a plurality of contact points for a pipe to maintain a particular orientation of the pipe as it slides through guide insert 108.

According to some embodiments, threading die 110 is designed to fit into second opening 106 of housing 102 and includes the cutting teeth that are used to thread the pipe. Threading die 110 may be machined from a single block of material, or threading die 110 may be composed of different pieces that are glued, welded, or otherwise coupled together. Threading die 110 may be made of stainless steel or any other metal material. Threading die 110 has an inner diameter that may be sized for a particular pipe diameter. In some embodiments, the inner diameter of threading die 110 is adjustable for use with different pipe sizes. In some other embodiments, different threading dies 110 having different inner diameters, or different teeth sizes, can be interchangeably used within housing 102.

Guide insert 108 and threading die 110 may be aligned within housing 102 along an axis 114. When in use, a pipe is inserted into first opening 104 along axis 114 and slides through guide insert 108 up until the pipe reaches threading die 110. One or both of housing 102 and threading die 110 is then rotated about axis 114 to cut into the pipe and create the threading pattern. The rotation of housing 102 may be performed by applying torque to one or more handles 112 extending radially outward from housing 102. The torque may be applied manually by an operator or by a machine. In some embodiments, handles 112 are omitted and housing 102 is rotated by a machine.

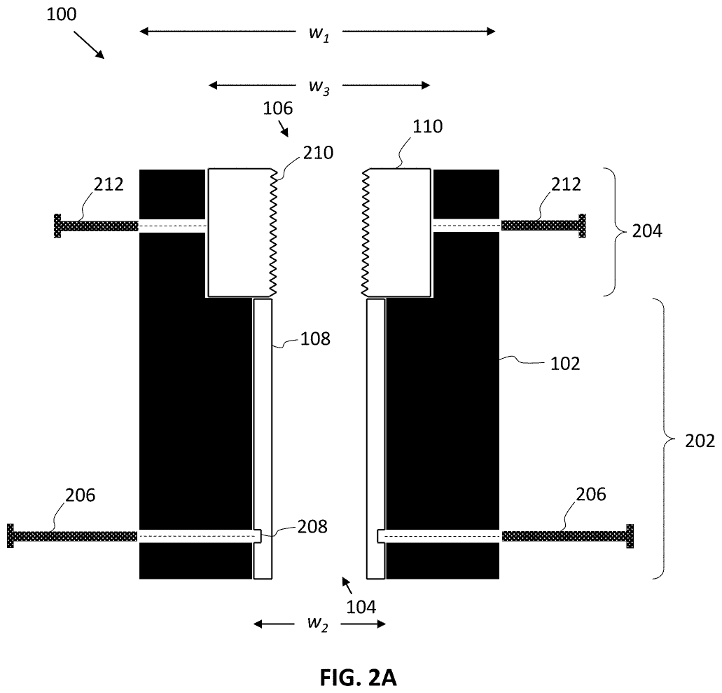

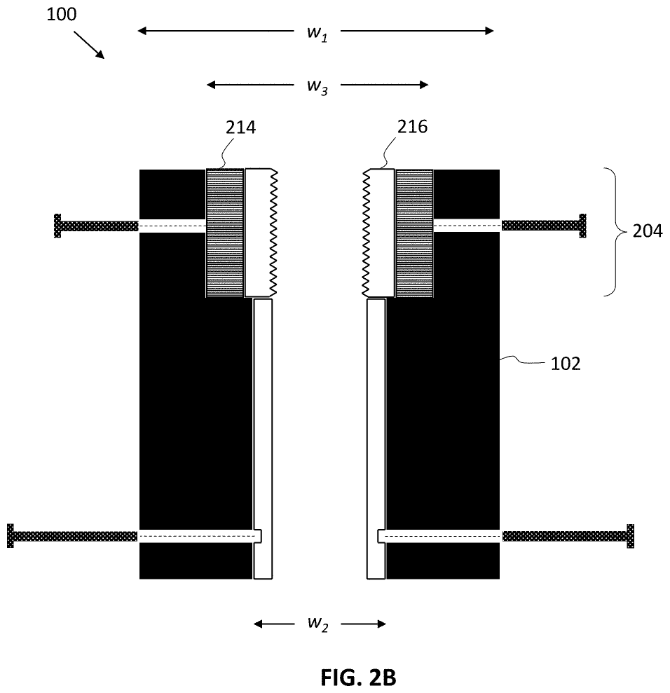

FIG. 2A illustrates a cross-section view of threading tool 100 having both guide insert 108 and threading die 110 positioned within housing 102, according to an embodiment. Housing 102 defines a plurality of internal regions within the housing into which different elements may be disposed. For example, housing 102 defines a first internal region 202 adjacent to first opening 104 and a second internal region 204 adjacent to second opening 106. Housing 102 may have a width w₁ between about 2.5 inches and about 5 inches. Housing 102 may have a cylindrical shape in which case width w₁ represents a diameter of housing 102.

First region 202 may be shaped to fit guide insert 108 and may have a width w₂ between about 0.5 inches and about 2 inches. Greater widths are possible as well to accommodate larger pipe diameters. First region 202 may have a cylindrical shape in which case width w₂ represents a diameter of first region 202. Guide insert 108 may be designed to fit within first region 202. According to some embodiments, guide insert 108 is removably secured within first region 202 using one or more fasteners 206 that extend through openings in housing 102 to apply pressure on guide insert 108 and hold it in place. Fasteners 206 may be screws, nails, or any other type of structure that maintains the position of guide insert 108. In some embodiments, guide insert 108 snaps into first region 202 using bent metal clips or springs. In some embodiments, guide insert 108 includes a recess 208 that extends around a perimeter (e.g., circumference) of a portion of guide insert 108. Fasteners 206 may contact guide insert 108 within recess 208 (e.g., fits within the recess) to better secure guide insert 108 in first region 202. Although two fasteners 206 are illustrated, any number of fasteners 206 can be used to secure guide insert 108. According to an embodiment, fasteners 206 can be loosened to allow for simple removal of guide insert 108 from first region 202. In this way, another guide insert (e.g., having a different inner diameter size to fit a different pipe diameter) can be inserted into first region 202 and secured using fasteners 206.

Second region 204 may be shaped to fit threading die 110 and may have a width w₃ between about 1.5 inches and about 3 inches. Greater widths are possible as well to accommodate larger pipe diameters. Second region 204 may have a cylindrical shape in which case width w₃ represents a diameter of second region 204. Second region 204 may be designed to fit a standard sized threading die 110. Threading die 110 includes teeth 210 for cutting the threading pattern into a pipe. According to some embodiments, threading die 110 is removably secured within second region 204 using one or more fasteners 212 that extend through openings in housing 102 to apply pressure on threading die 110 and hold it in place. Fasteners 212 may be screws, nails, or any other type of structure that maintains the position of threading die 110. In some embodiments, threading die 110 snaps into second region 204 using bent metal clips or springs. Although two fasteners 212 are illustrated, any number of fasteners 212 can be used to secure threading die 110. According to an embodiment, fasteners 212 can be loosened to allow for simple removal of threading die 110 from second region 204. In this way, another threading die (e.g., having a different inner diameter size to fit a different pipe diameter, or having a different tooth structure) can be inserted into second region 204 and secured using fasteners 212. According to some embodiments, threading die 110 rests upon a ledge within housing 102 that separates first region 202 from second region 204.

FIG. 2B illustrates another embodiment of threading tool 100 using an adapter structure 214. In some examples, a threading die 216 having a smaller size (e.g., a smaller diameter) than second region 204 can be disposed within an adapter structure 214. As illustrated, second region 204 may be sized to fit adapter structure 214. In this way, various sized threading dies can be used with the same housing 102.

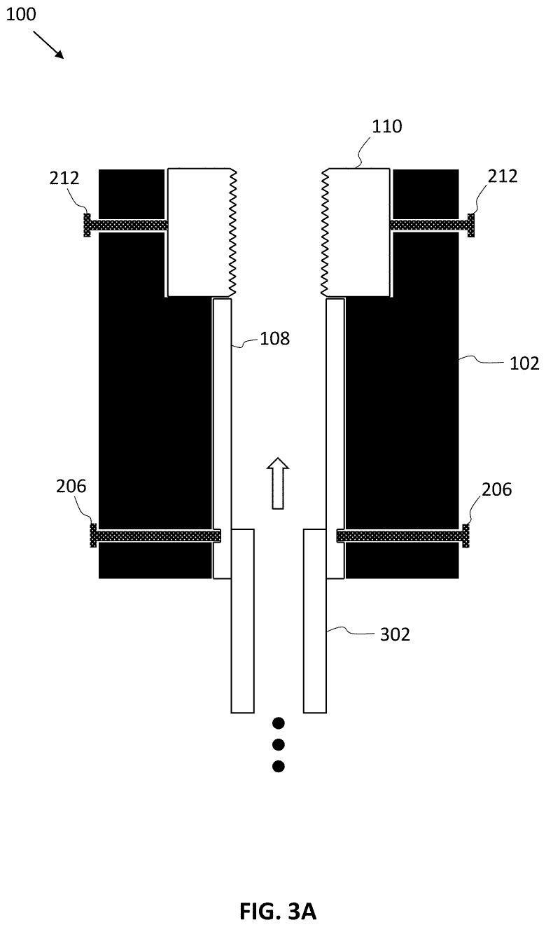

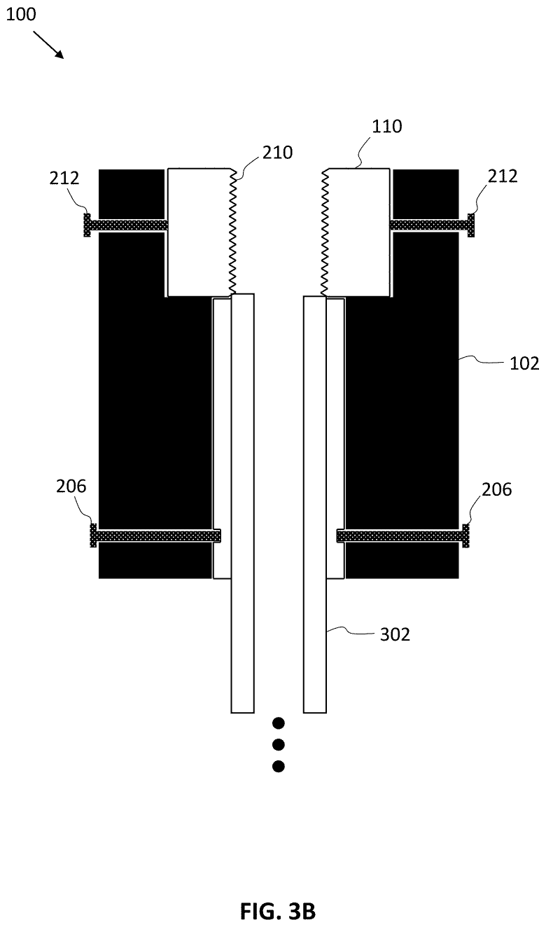

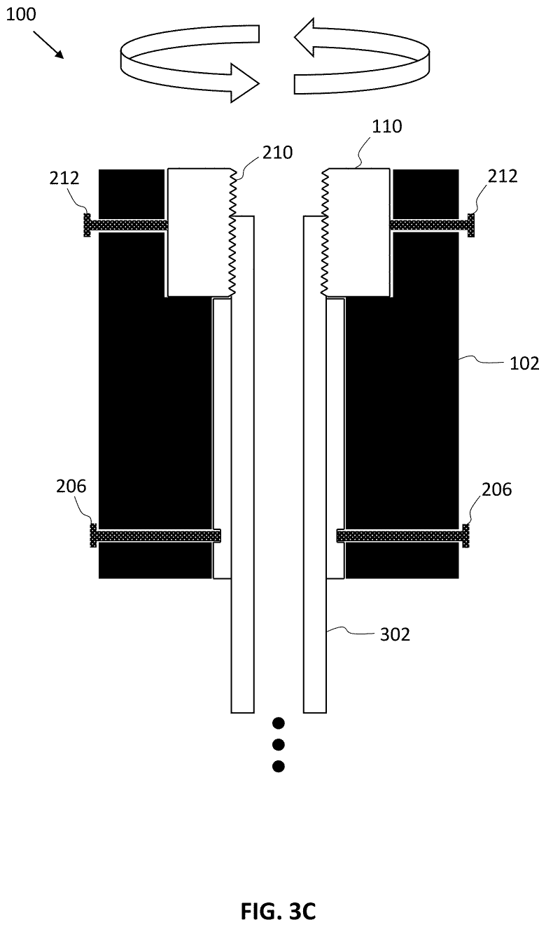

FIGS. 3A-3C illustrate cross-sectional views of threading tool 100 during the insertion and threading of a pipe 302, according to some embodiments. As noted above, pipe 302 can also be a solid rod that is inserted into threading tool 100 in order to thread an end of the solid rod. FIG. 3A illustrates the initial insertion of pipe 302 into first opening 104. As indicated by the arrow, pipe 302 slides past guide insert 108 as it moves through housing 102. Guide insert 108 has an inner diameter that either matches or is slightly larger than the outer diameter of pipe 302, thus maintaining pipe 302 at a particular orientation as it slides through guide insert 108. In this way, pipe 302 engages with threading die 110 at a substantially (e.g., within at least 1 degree) 90-degree angle as it slides past guide insert 108. During the threading procedure illustrated in FIGS. 3A-3C, fasteners 206 are engaged with guide insert 108 to secure guide insert 108 within housing 102. Similarly, fasteners 212 are engaged with threading die 110 to secure threading die 110 within housing 102.

FIG. 3B illustrates a situation where pipe 302 has slid through guide insert 108 up until it encounters a portion of threading die 110. In some embodiments, pipe 302 contacts teeth 210 of threading die 110.

FIG. 3C illustrates the threading process where at least one of housing 102 and threading die 110 are rotated (as indicated by the arrows) about pipe 302. The rotation causes teeth 210 to bite into pipe 302 and slowly move down the length of pipe 302 as the rotation continues. In some examples, the rotation is reversed after a period to clean out the metal slivers from the threaded region of pipe 302.

### Example Methodology

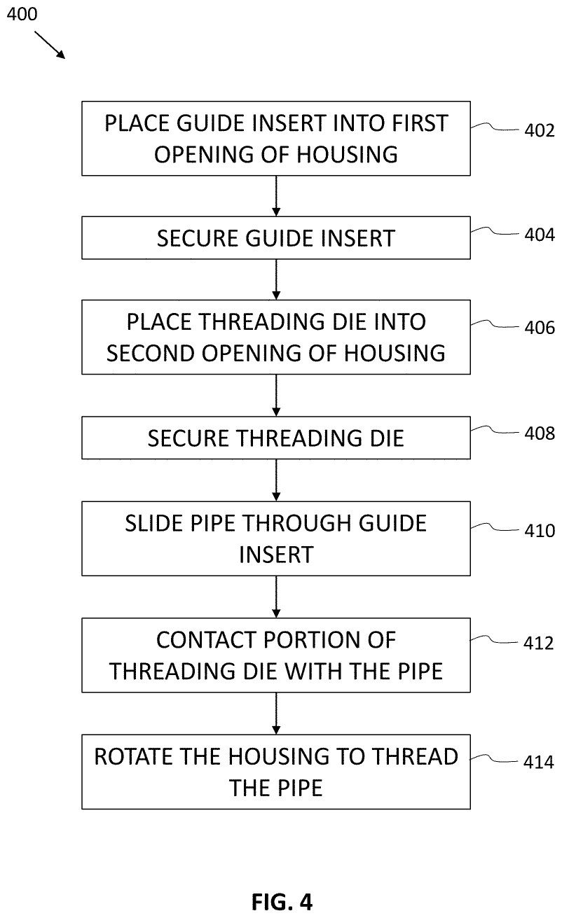

FIG. 4 is a flow chart of a method 400 for using a threading tool having a guide insert, according to some embodiments. Various operations of method 400 may be illustrated in FIGS. 3A-3C. However, the correlation of the various operations of method 400 to the specific components illustrated in FIGS. 3A-3C is not intended to require any structural and/or use limitations. Rather, FIGS. 3A-3C provide one example embodiment of method 400. Other operations may be performed before, during, or after any of the operations of method 400.

Method 400 begins at operation 402 where a guide insert is placed into a first opening of a housing. The guide insert may be secured within a first region of the housing and may have an inner diameter sized to fit snuggly around a pipe of a given size. Different guide inserts having different inner diameters may be used to fit different pipe sizes.

Method 400 continues with operation 404 where the guide insert is secured. The guide insert may be removably secured using any suitable mechanism. According to some embodiments, the guide insert is secured in a first region of the housing by tightening one or more screws.

Method 400 continues with operation 406 where a threading die is placed into a second opening of a housing. The second opening may be located at an opposite end of the housing from the first opening. The threading die may be secured within a second region of the housing and may include one or more rows of teeth for cutting the threading pattern into a pipe. Different threading dies having different inner diameters and/or tooth designs may be interchangeably used within the threading tool.

Method 400 continues with operation 408 where the threading die is secured. The threading die may be removably secured using any suitable mechanism. According to some embodiments, the threading die is secured in a second region of the housing by tightening one or more screws. In some other embodiments, the threading die is permanently secured within the housing, such that the threading tool only includes one threading die design.

It will be appreciated that operations 402-408 may be performed in any order. Furthermore, in some embodiments, operations 406 and 408 may be skipped in situations where the threading die is already secured in the threading tool.

Method 400 continues with operation 410 where a pipe (or rod) slides through the guide insert. The pipe may be brought towards the first opening and slid into the guide insert, or the threading tool may be brought towards the pipe such that the guide insert slides down over the end of the pipe. The guide insert is dimensioned for a given pipe size, such that the pipe slides snuggly through the guide insert and such that the pipe's orientation with respect to the threading tool is maintained at a substantially 90 degree angle. In some examples, the inner shape of the guide insert is not cylindrical, but rather contacts the pipe at a plurality of contact points along a length of the pipe to maintain the orientation of the pipe.

Method 400 continues with operation 412 where a portion of the threading die is contacted with the pipe. According to some embodiments, the pipe slides through the length of the guide insert until it contacts the threading die. In one example, the pipe contacts the teeth of the threading die. In some other examples, the pipe slides through the guide insert and leaves a portion of the pipe sticking out of the end of the guide insert, after which a threading die is clamped around a portion of the end of the pipe sticking out from the guide insert.

Method 400 continues with operation 414 where at least one of the housing and threading die is rotated about the end of the pipe to create the threading pattern in the pipe. The rotation may be aided by one or more handles that extend radially away from the housing. The rotation may be performed in one direction for a period of time, followed by rotation in the opposite direction to clean out the threaded portion of the pipe.

Numerous specific details have been set forth herein to provide a thorough understanding of the embodiments. It will be understood in light of this disclosure, however, that the embodiments may be practiced without these specific details. In other instances, well known operations and components have not been described in detail so as not to obscure the embodiments. It can be appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### FURTHER EXAMPLE EMBODIMENTS

The following examples pertain to further embodiments, from which numerous permutations and configurations will be apparent.

Example 1 is a threading tool comprising a housing and a guide insert. The housing comprises a first opening at one end and a second opening at an opposite end. The housing defines a first region having a first width adjacent to the first opening and a second region having a second width adjacent to the second opening, the second width being greater than the first width. The guide insert is configured to fit through the first opening, and the guide insert is removably secured within the first region. The second region is shaped to fit a threading die, the threading die being removably secured in the second region.

Example 2 includes the subject matter of Example 1, wherein the housing has a cylindrical shape.

Example 3 includes the subject matter of Example 2, wherein an outer diameter of the housing is between about 2.5 inches and about 5 inches.

Example 4 includes the subject matter of any one of Examples 1-3, wherein the first width is a diameter that is between about 0.5 inches and about 2 inches.

Example 5 includes the subject matter of any one of Examples 1-4, wherein the second width is a diameter that is between about 1.5 inches and about 3 inches.

Example 6 includes the subject matter of any one of Examples 1-5, further comprising one or more handles extending radially outwards from the housing.

Example 7 includes the subject matter of any one of Examples 1-6, wherein the guide insert has a cylindrical shape with a recess around a circumference of a portion of the guide insert.

Example 8 includes the subject matter of Example 7, wherein one or more screws secure the guide insert by contacting the guide insert within the recess.

Example 9 includes the subject matter of any one of Examples 1-8, wherein the guide insert has a length between about 0.5 inches and about 1.5 inches.

Example 10 includes the subject matter of any one of Examples 1-9, further comprising one or more screws configured to removably secure the guide insert in the first region.

Example 11 includes the subject matter of any one of Examples 1-10, further comprising one or more screws configured to removably secure the threading die in the second region.

Example 12 includes the subject matter of any one of Examples 1-11, further comprising an adapter structure, wherein the adapter structure is configured to be removably secured within the second region and the adapter structure is configured to hold the threading die.

Example 13 is a method of using a threading tool. The method includes placing a threading die into a first opening of a tool housing such that the threading die rests in a first region within the tool housing; securing the threading die in the first region of the tool housing; placing a guide insert into a second opening of the tool housing, such that the guide insert enters a second region within the tool housing; removably securing the guide insert in the second region of the tool housing; sliding a pipe or rod through the guide insert such that an end of the pipe or rod contacts a portion of the threading die; and rotating the tool housing about the end of the pipe or rod.

Example 14 includes the subject matter of Example 13, wherein securing the threading die comprises rotating one or more screws to hold the threading die in place in the first region.

Example 15 includes the subject matter of Example 13 or 14, wherein removably securing the guide insert comprises rotating one or more screws to hold the guide insert in place in the second region.

Example 16 includes the subject matter of Example 15, wherein the one or more screws rotate into a recess around an outer perimeter of the guide insert.

Example 17 includes the subject matter of any one of Examples 13-16, wherein rotating the tool housing comprises rotating the tool housing by applying torque to one or more handles extending radially outwards from the tool housing.

Example 18 includes the subject matter of any one of Examples 13-17, further comprising removing the guide insert from the tool housing and placing a second guide insert into the second opening of the tool housing, such that the second guide insert enters the second region within the tool housing.

Example 19 includes the subject matter of any one of Examples 13-18, further comprising removing the threading die from the tool housing and placing a second threading die into the first opening of the tool housing, such that the second threading die rests in the first region within the tool housing.

Example 20 includes the subject matter of any one of Examples 13-19, wherein placing the threading die into the first opening of the tool housing comprises placing the threading die into an adapter structure and placing the adapter structure into the first opening of the tool housing.

1. A threading tool, comprising:
a housing comprising a first opening at one end and a second opening at an opposite end, the housing defining a first region having a first width adjacent to the first opening and a second region having a second width adjacent to the second opening, the second width being greater than the first width; and
a guide insert configured to fit through the first opening, wherein the guide insert is removably secured within the first region,
wherein the second region is shaped to fit a threading die, the threading die being removably secured in the second region.

2. The threading tool of claim 1, wherein the housing has a cylindrical shape.

3. The threading tool of claim 2, wherein an outer diameter of the housing is between about 2.5 inches and about 5 inches.

4. The threading tool of claim 1, wherein the first width is a diameter that is between about 0.5 inches and about 2 inches.

5. The threading tool of claim 1, wherein the second width is a diameter that is between about 1.5 inches and about 3 inches.

6. The threading tool of claim 1, further comprising one or more handles extending radially outwards from the housing.

7. The threading tool of claim 1, wherein the guide insert has a cylindrical shape with a recess around a circumference of a portion of the guide insert.

8. The threading tool of claim 7, wherein one or more screws secure the guide insert by contacting the guide insert within the recess.

9. The threading tool of claim 7, wherein the guide insert has a length between about 0.5 inches and about 1.5 inches.

10. The threading tool of claim 1, further comprising one or more screws configured to removably secure the guide insert in the first region.

11. The threading tool of claim 1, further comprising one or more screws configured to removably secure the threading die in the second region.

12. The threading tool of claim 1, further comprising an adapter structure, wherein the adapter structure is configured to be removably secured within the second region and the adapter structure is configured to hold the threading die.

13-20. (canceled)

21. The threading tool of claim 1, wherein an inner diameter of the guide insert is configured to be adjustable.

22. The threading tool of claim 7, wherein the guide insert has an inner diameter between about 0.2 inches and about 1.75 inches.

23. The threading tool of claim 1, wherein the housing further comprises one or more bent metal clips or springs configured to secure the guide insert in the first region.

24. The threading tool of claim 1, wherein the first region of the housing has a cylindrical shape.

25. The threading tool of claim 24, wherein the second region of the housing has a cylindrical shape.

26. The threading tool of claim 1, wherein the guide insert and the threading die are aligned along an axis passing through a center of the guide insert and the threading die when the guide insert and the threading die are secured within the first region and the second region, respectively.

27. The threading tool of claim 6, wherein a torque applied to the one or more handles rotates the housing about an axis passing through a center of the housing.

28. The threading tool of claim 1, wherein the guide insert comprises an inner shape having a plurality of contact points configured to make contact with a cylindrical object placed through the guide insert.
